(19) United States
(12) Patent Application Publication
(10) Pub. No.: US 2009/0051134 A1
(43) Pub. Date: Feb. 26, 2009

(54) SUPPORT STAND FOR AN INLINE TWO WHEELED VEHICLE

(76) Inventor: Steven R. Clugston, Bloomington, IL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/841,204

(22) Filed: Aug. 20, 2007

(51) Int. Cl. B62M 1/00

(52) U.S. Cl. 280/87.041

(57) ABSTRACT

A support stand for supporting an inline two-wheeled vehicle has a base that rests directly upon the ground and two ears that project upward from the base and define a cavity there between for receipt of a wheel and forks of the vehicle. Preferably, the ears are resiliently flexible and exert a biasing force against the forks when the scooter is mounted to the stand.

### TECHNICAL FIELD

The present invention relates to a support stand for a vehicle and more particularly to a support stand for a two-wheeled vehicle that has a low center of gravity.

### BACKGROUND

Known two wheeled vehicles are generally described as being “inline” because the rear wheel generally follows along the same path as the rear wheel. Two wheeled inline vehicles may include any variety of transportation devices including bicycles and scooters. Because of the high center of gravity (i.e. the bicycle frame is high off the ground), bicycles are known to include on-board kickstands that function to prop the bicycle in an upright position when not in use. Other two wheeled vehicles, such as scooters, with low centers of gravity are not readily able to carry kick stands, thus scooters and other two wheeled vehicles with low centers of gravity are typically laid to rest on their sides or often inconveniently propped up against a wall.

One type of scooter stand is disclosed in U.S. Publication No. 2006/0169861. This type of scooter stand is designed to selectively clip to the bottom portion of the front wheel for storing the scooter in an upright position when the scooter is not in use, and clip to a frame portion of the scooter when the scooter is in use. The design attributes of this particular stand (i.e. clipping to the frame) tends to limit its ability to function as a support stand. For instance, the scooter must be lifted and the stand then clipped to the wheel. Moreover, because a scooter wheel is relatively small compared to the remaining structure of the scooter, the stand clip is small and only engages a small portion of the wheel, which is already small to begin with. This general lack of engagement to the scooter as a whole contributes toward stand instability. Moreover, there is no convenient means to simply ride the scooter up onto the support stand without potentially damaging the clip. Yet further, known scooter stands require multiple parts typically made of different materials that increase the cost of manufacturing.

### SUMMARY

A support stand for supporting an inline two-wheeled vehicle has a base that rests directly upon the ground and two ears that project upward from the base and defines a cavity there between for receipt of a wheel and forks of the vehicle. Preferably, the ears are resiliently flexible and exert a biasing force against the forks when the scooter is mounted to the stand.

The base preferably has a ramp portion that enables a user of the scooter to simply ride the scooter and thus roll the front wheel of the scooter slightly upward onto the stand and until the wheel drops down into a well of the cavity. Upon dropping, the weight of the user assists in biasing the ears against the forks of the scooter. Lateral portions of the base project outward in opposite direction and prevent the scooter and stand from tipping. Moreover, the lateral portions need only be stepped on when the scooter is lifted out of and separated from the stand.

Objects, features and advantages of the present invention include a conveniently usable support stand for a two-wheel vehicle that does not require use of the rider's hands when mounting the vehicle to the stand. Other advantages include a stand with superior stability when in use, does not scratch the vehicle, is relatively inexpensive to manufacture, is robust, light weight, requires little or no maintenance and in service has a long and useful life.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a side view of a support stand embodying the present invention and illustrated supporting a scooter;

FIG. 2 is a perspective view of the support stand supporting the scooter;

FIG. 3 is a rear perspective view of the support stand;

FIG. 4 is a cross section of the support stand illustrated in a flexed state and taken along line 4-4 of FIG. 2;

FIG. 5 is a cross section of the support stand similar in perspective to FIG. 4 except illustrated in an unflexed state; and

FIG. 6 is a cross section of the support stand taken along line 6-6 of FIG. 2.

### DESCRIPTION OF THE PREFERRED EMBODIMENT

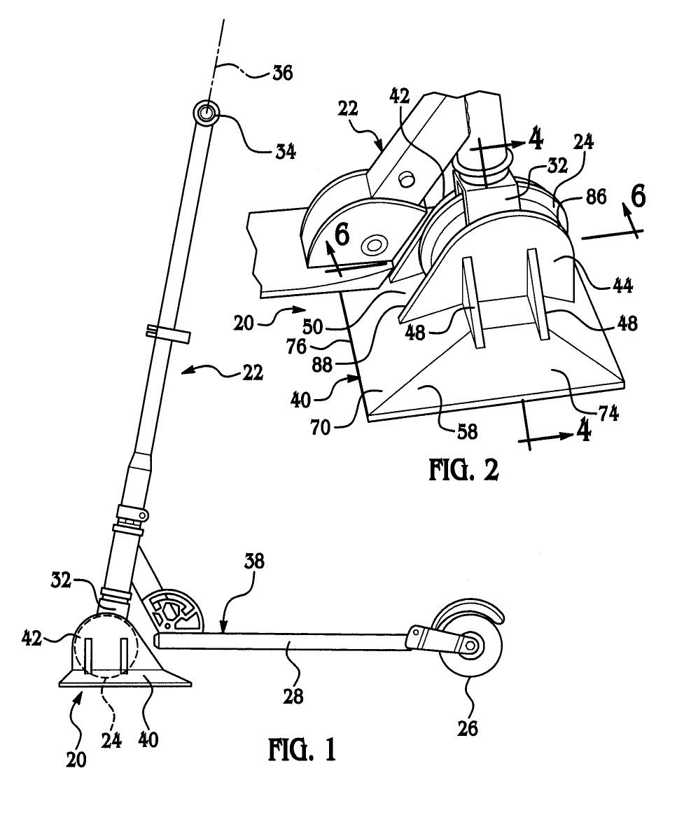

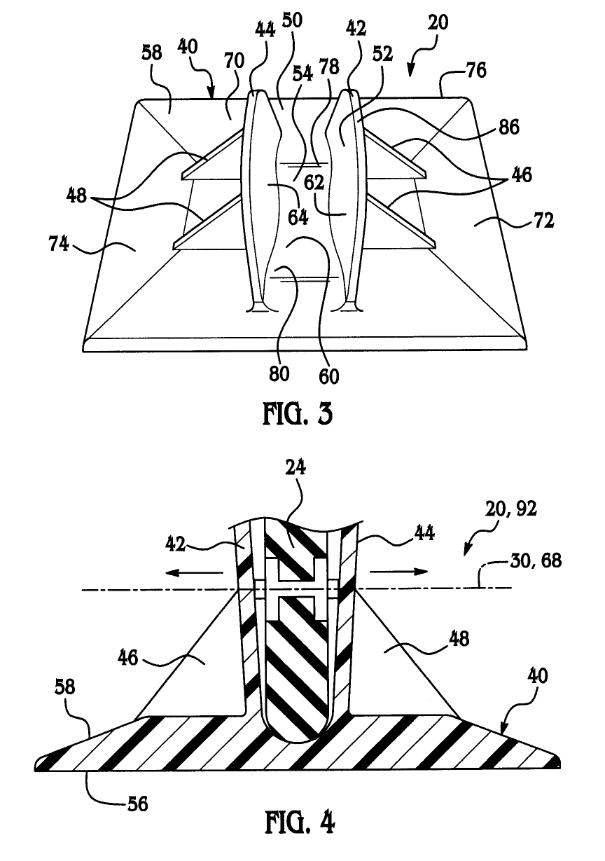

As illustrated in FIGS. 1-6, the present invention is a support stand 20 used for a two-wheeled vehicle 22 that may be of an inline type. Preferably, the two-wheeled vehicle 20 is a scooter having a low center of gravity contributable via front and rear wheels 24, 26 being relatively small in diameter and a low lying footplate or base board 28. The front wheel 24 is supported for rotation about a horizontal rotation axis 30 by forks 32 of the scooter 22. The forks 32 are connected rigidly to a steering device or bar 34 and both are connected pivotally along a pivot axis 36 to a base frame 38 of the scooter 22. The substantially horizontal pivot axis 36 is substantially perpendicular to the horizontal rotation axis 30.

The support stand 20 has a base 40, two substantially planar ears 42, 44 projecting upward from the base 40 and two pairs of substantially triangular braces 46, 48 extending between the base 40 and the respective ears 42, 44 for strength and durability. The ears 42, 44 are substantially parallel to one another and define a cavity 50 there between for convenient placement of the front wheel 24 and forks 32 of the scooter 22. The cavity 50 generally has an upper portion 52 defined by the ears 42, 44 and a lower well or lower portion 54 defined by the base 40. When the stand is in use, the annular tire portion of the front wheel 24 is fitted snugly in the well 54 and the forks 32 are snugly fitted between the ears 42, 44 and in the upper portion 52 of the cavity 50.

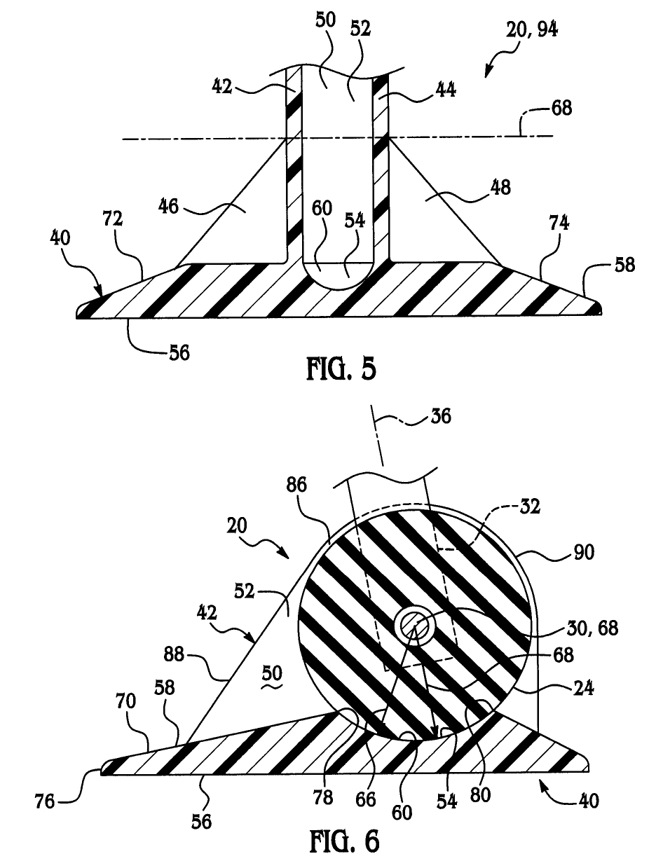

As best shown in FIGS. 5 and 6, the base 40 of the stand 20 carries a substantially planar bottom surface 56 that is in direct contact with the surrounding ground, pavement, or floor of a structure such as a garage. A top surface 58 of the base 40 is generally contoured and defines the well 54 of the cavity 50. An arcuate or cylindrical segment 60 of the top surface 58 is concave and generally defines the bottom of the well 54. Opposing side segments 62, 64 of the top surface 58 are substantially planar and vertical, thus being or defining the sides of the well 54. Preferably, the cylindrical segment 60 of the top surface 58 has a radius of curvature, illustrated by arrow 66, that is measured from a horizontal centerline 68. Because the centerline 68 and the rotation axis 30 of the front wheel 24 generally co-extend with one another when the scooter 22 is positioned on the stand 20, the radius 66 of the well 54, or cylindrical segment 60, is substantially equal to a radius 68 of the wheel 24. This contributes toward a close and stable fit of the scooter 22 to the stand 20.

The base 40 also has a ramp portion 70, and two opposite lateral support portions 72, 74 that together carry the bottom and top surfaces 56, 58. The ramp portion 70 tapers outward in the forward direction from a forward edge 76 of the base 40 that generally defines the congruent union of the bottom and top surfaces 56, 58. From the forward edge 76, which lies substantially flush with the ground or pavement, the ramp portion 70 spans in a forward direction and slightly upward until it meets the well 54 or forward rim or stop 78 of the cylindrical segment 60 of the top surface 58. Preferably, the cylindrical segment 60 spans longitudinally from the forward rim 78 and to a rearward rim or stop 80. Location of the wheel 24 between the forward and rearward rims 78, 80 provides a positive indication to the user of the scooter 22 that the wheel 24 is properly located in the stand 20, and prevents unintended movement of the scooter 22 in the forward and rearward directions.

The lateral support portions 72, 74 project in opposite horizontal directions from one another (i.e. generally parallel to centerline 68) and prevent the scooter 22 and stand 20 from tipping over. The brace pairs 46, 48 span between the respective ears 42, 44 and respective support portions 72, 74.

The ears 42, 44 have opposing inner faces 82 that define the upper portion 52 of the cavity 50 and opposite outer faces 84 formed to the respective braces 46, 48. The inner faces 82 are preferably flush with and parallel to the respective side segments 62, 64 of the contoured top surface 58. As best shown in FIGS. 4 and 5, the ears 42, 44 are resiliently flexible for exerting a biasing force against the forks 32 of the scooter 22 when engaged. The brace pairs 44, 46 of the stand 20 are design to add durability and repeat performance, however, because the braces also add rigidity the ears 42, 44, the individual braces of each pair 44, 46 are spaced apart from one another at a sufficient distance to place the forks 32 of the scooter 22 between the braces of each brace pair.

Each ear 42, 44 has an outer peripheral edge 86 having a forward or first segment 88 and a second segment 90. The forward segment 88 is generally straight and spans from the top surface 58 of the base 40 at the ramp portion 70 to the second segment 90. The second segment 90 is arcuate and generally conforms to the circumference of the wheel 24. The forward segment 88 forms to the ramp portion 70 forward of the apex or stop 78 and slopes in the forward direction as the ears 42, 44 span upward. This sloping relationship aids in the wedging-like receipt of the wheel 24 when the scooter 22 is placed in the stand 20.

When installing the scooter 22 to the stand 20, the user or rider need only roll the front wheel 24 up the ramp portion 70 of the base 40. The annular curvature of the wheel 24 first contacts one or both of the forward segments 88 of the peripheral edges 86 of the respective ears 42, 44. Continued forward movement and rolling of wheel 24 up the ramp portion 70 causes the leading portion of the wheel to be guided or slightly wedged between the ears. The weight of the scooter 22 upon the base 40 keeps the stand 20 stationary and grounded to the floor without requiring the use to bend over and grip the stand. The wheel 24 continues to move into the upper portion 52 of cavity 50 until it rolls over the stop 78 at which point the wheel generally drops down into the well 54 signifying mounting completion of the scooter 22 to the stand 20. Stop 80 prevents unintended over travel of the scooter 22 with respect to the stand 20. The weight of the scooter 22 wedges the forks 32 between the ears 42, 44 when the wheel 24 drops into the well 54.

When mounted, the ears 42, 44 are resiliently flexed slightly outward into a flexed state 92 (see FIG. 4) and with respect to one another, thus exert a biasing force directly upon the forks 32 of the scooter. When dismounting the scooter 22 from the stand 20, the rider need only step on the base 40 of the stand 20 and lift and/or roll the scooter out of the cavity 50 in a reverse or reward direction. Preferably, stepping on either one of the lateral support portions 72, 74 of the base 40 is sufficient to keep the stand 20 grounded while the scooter is removed. Upon removal of the scooter 22, the resiliency of the ears 42, 44 causes the ears to flex back inward or toward one another and into a natural or unflexed state 94 (see FIG. 5).

Preferably, the stand 20 is unitary and does not require assembly of multiple components thus reducing manufacturing costs. The homogenous material of the stand 20 is preferably made of a resiliently flexible material, and is somewhat pliable to avoid scratching the forks 32 and is preferably rust resistant. One such material is that of plastic, and to minimize manufacturing costs, preferably injection molded plastic.

While the forms of the invention herein disclosed constitute presently preferred embodiments, many others are possible. It is not intended herein to mention all the possible equivalent forms or ramification of the invention. It is understood that terms used herein are merely descriptive, rather than limiting, and that various changes may be made without departing from the spirit or scope of the invention.

1. A stand for supporting an inline two-wheeled vehicle having forks for pivoting about a steering axis and for rotationally supporting a wheel of the vehicle, the stand comprising:
a base; and
opposing first and second ears projecting upward from said base and defining a cavity there between for receipt of the wheel and the forks.

2. The stand set forth in claim 1 wherein said ears are resiliently flexible for exerting a biasing force against the forks.

3. The stand set forth in claim 1 further comprising a ramp portion of said base disposed forward of said first and second ears.

4. The stand set forth in claim 3 further comprising an arcuate well of said cavity defined by said base portion and generally between said ears.

5. The stand set forth in claim 4 wherein said well has a radius of curvature for generally fitting to a radius of curvature of the wheel.

6. The stand set forth in claim 3 further comprising said first and second ears each having an outer peripheral edge having a forward segment that extends upward from the base and in a forward direction for wedging receipt of the wheel and forks.

7. The stand set forth in 6 wherein the forward segment projects upward from the ramp portion.

8. The stand set forth in claim 1 wherein the stand is of a unitary and one piece design.

9. The stand set forth in claim 8 wherein the stand is made of injection molded plastic.

10. The stand set forth in claim 1 further comprising:
said base having opposite first and second lateral support portions projecting in opposite directions from said well, wherein the first ear projects upward from said first support portion and the second ear projects upward from said second support portion.
said first and second ears each having inner and outer faces wherein the inner faces define at least in part said cavity;
a first brace spanning between said first support portion and said outer face of said first ear; and
a second brace spanning between said second support portion and said outer face of said second ear.

11. The stand set forth in claim 5 wherein said well has an angular displacement of about forty-five to ninety degrees.

12. A stand for supporting an inline two-wheeled vehicle having forks for pivoting about a steering axis and for rotationally supporting a wheel of the vehicle about a rotational axis, the stand comprising:
a base having a planar bottom surface and a contoured top surface;
an arcuate well for rolling receipt of the wheel, said well being defined by said top surface and having a radius of curvature measured from a centerline; and
wherein said centerline co-extends with said rotational axis when the wheel is in said well.

13. The stand set forth in claim 12 further comprising opposing first and second ears projecting upward from said top surface on respective sides of said well and beyond said centerline.

14. The stand set forth in claim 13 wherein said first and second ears are resiliently flexible for exerting a biasing force upon the forks when the wheel is in said well.

15. The stand set forth in claim 14 wherein said base has a ramped portion for rolling the wheel up to then into said well.

16. The stand set forth in claim 15 wherein said stand is unitary, one piece and made of a singular homogeneous material.
